(19) United States
(12) Patent Application Publication
(10) Pub. No.: US 2009/0033449 A1
(43) Pub. Date: Feb. 5, 2009

(54) ELECTRONIC DEVICE

(75) Inventor: Chi-Fang Liu, Nantou County (TW)

Correspondence Address: QUINTERO LAW OFFICE, PC, 2210 MAIN STREET, SUITE 200, SANTA MONICA, CA, 90405, US

(73) Assignee: QISDA CORPORATION, TAOYUAN (TW)

(21) Appl. No.: 12/183,996

(22) Filed: Jul. 31, 2008

(30) Foreign Application Priority Data
Aug. 3, 2007 (TW) TW96128567

(51) Int. Cl. H01F 7/14

(52) U.S. Cl. 335/272

(57) ABSTRACT

An electronic device includes a housing, a connecting member and a roller. The housing has a track and an aperture. The connecting member moves along the track. The roller rotatably connects with an end of the connecting member. The connecting member moves the roller to be exposed through the aperture or concealed in the housing.

### BACKGROUND OF THE INVENTION

1. Field of the Invention

The invention relates to an electronic device, and in particular, to an electronic device with a concealed roller.

2. Description of the Related Art

Mobile phones usually comprise a roller disposed on a side of the body the phone. Users control the rotation of the roller in order to make choices from the menu, or press the roller to confirm selection.

For the convenience of rotating or pressing the roller, the roller is protruded from the body of the phone. However, the roller protruded from the body creates unsymmetrical design. Additionally, when the mobile phone is placed in the pocket of the user, the protruded roller causes discomfort.

### BRIEF SUMMARY OF THE INVENTION

The invention provides an electronic device. The electronic device includes a housing, a connecting member and a roller. The housing has a track and an aperture. The connecting member moves along the track. The roller rotatably connects with an end of the connecting member. The connecting member moves the roller to be exposed through the aperture or concealed in the housing.

The invention provides another electronic device including a housing, a connecting member and a roller. The housing has a track. The connecting member moves along the track between a first position and a second position. The roller rotatably connects with an end of the connecting member. The connecting member moves from the first position to the second position, moving the roller from a third position to a fourth position.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of an electronic device of the invention;

FIGS. 2A and 2B are schematic views showing a portion of the interior of the electronic device;

FIG. 3A-3D are schematic views showing paths of a connecting member moving along a track; and

FIG. 4 is a schematic view of the track of the invention.

### DETAILED DESCRIPTION OF THE INVENTION

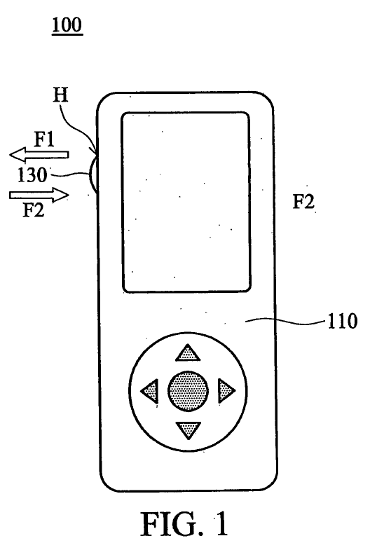

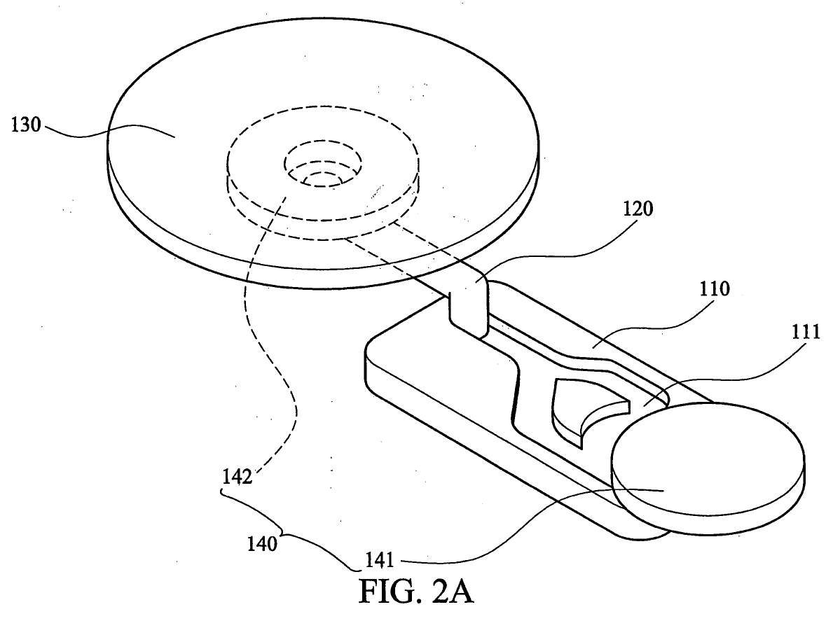

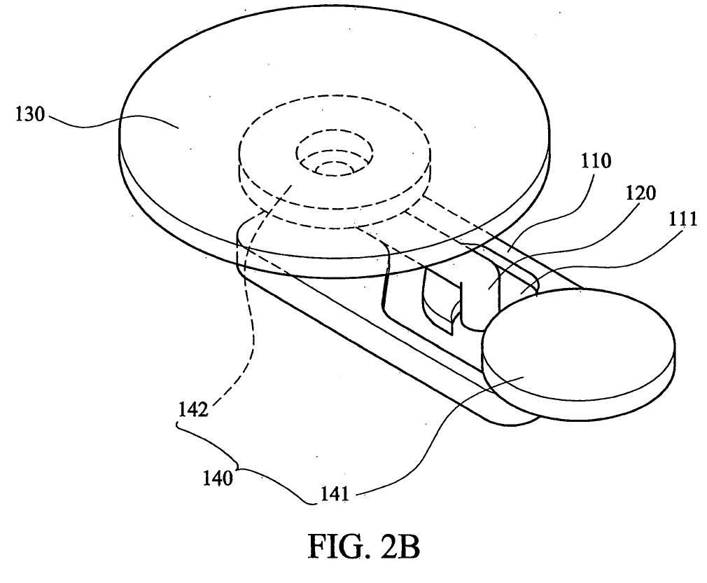

Referring to FIG. 1, the invention provides an electronic device 100, which is a mobile device. The electronic device 100 comprises a housing 110, a connecting member 120 (as shown in FIGS. 2A and 2B), and a roller 130, wherein the roller 130 is disposed in the housing 110 by the connecting member 120.

FIGS. 2A and 2B are schematic views showing a portion of the interior of the electronic device. The housing 110 comprises a track 111, and an aperture H (as shown in FIG. 1) is formed on the housing 110. An end of the connecting member 120 is disposed in the track 111, moving between a first position (as shown in FIG. 2A) and a second position (as shown in FIG. 2B).

The roller 130 connects with another end of the connecting member 120 in a rotatable manner. Further, the roller 130 electrically couples the electronic device 100, and inputs signals to the electronic device 100 by rotation. Sliding along the track 111, the connecting member 120 moves the roller 130 between a third position (as shown in FIG. 2A) and a fourth position (as shown in FIG. 2B). When the connecting member 120 is in the first position, the roller 130 is in the third position, and when the connecting member 120 is in the second position, the roller 130 is in the fourth position.

The electronic device 100 further comprises a magnetic set 140. The magnetic set 140 has a first magnet 141 and a second magnet 142, facing each other with the same poles (both are N poles or S poles). The first and second magnets 141, 142 are respectively disposed on the housing 110 and the roller 130, providing repulsive force to the housing 110 and the roller 130.

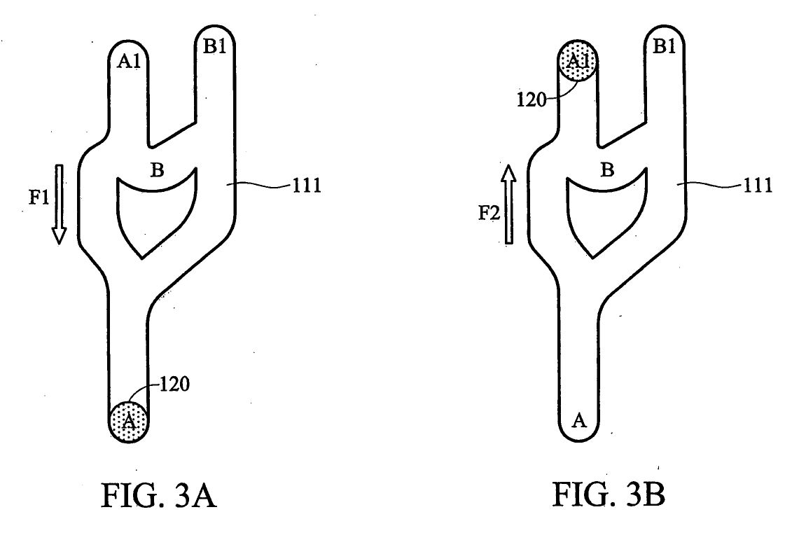

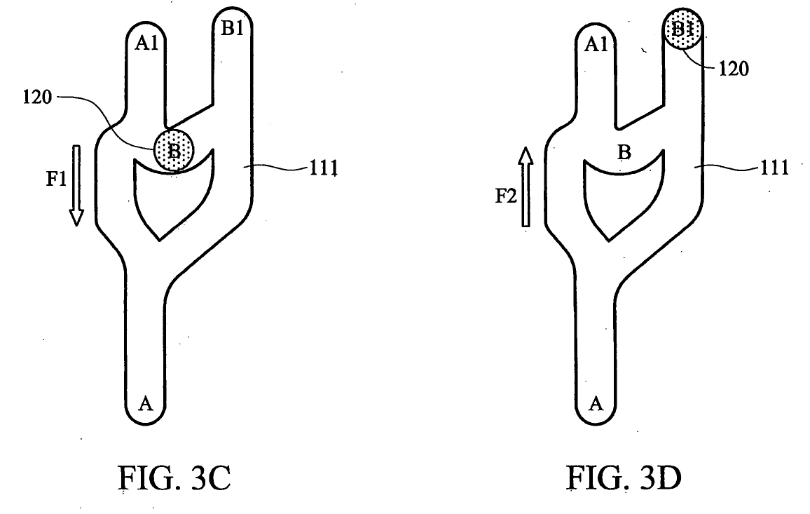

Referring to FIGS. 3A to 3C, when the connecting member 120 is in position A, the first magnet 141 and the second magnet 142 provide repulsive force to push the connecting member 120 in a first direction F1, allowing the connecting member 120 to be positioned in the first position A (as shown in FIG. 3A), and the roller to be positioned in the third position. Meanwhile, a portion of the roller 130 is exposed through the aperture H.

To conceal the roller 130 within the housing 110, or to change the position of the roller, an external force is applied to overcome the repulsive force between the first magnet 141 and the second magnet 142, such that the roller 130 is pressed to a second direction F2, sliding the connecting member 130 from the first position A to a first transition A1 (as shown in FIG. 3B). Next, the roller 130 is released, such that the repulsive force between the first magnet 141 and the second magnet 142 pushes the connecting member 120 to the first direction F1 again, allowing the connecting member 120 to slide from the first transition A1 to the second position B. As a result, the connecting member 120 is positioned in the second position B (as shown in FIG. 3C), and the roller 130 is positioned in the fourth position, completely concealed in the housing 110.

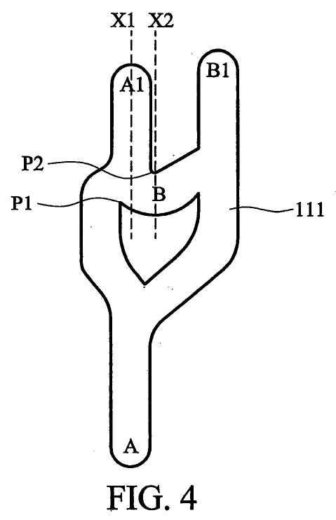

Referring to FIG. 4, during sliding of the connecting member 120 from the first transition A1 to the second position B, the connecting member 120 passes a first point P1. Because a first axis (center line of the track) X1 shifts from the first point P1, the first point P1 blocks the back path to the first position A, preventing the connecting member 120 from sliding counter-clockwise. Thereby, allowing the connecting member 120 to slide clockwise to the second position B.

Referring to FIGS. 3A and 3D, to expose the roller 130 from the housing 110, an external force is again applied to overcome the repulsive force between the first magnet 141 and the second magnet 142, such that the roller is pressed to the second direction F2, sliding the connecting member 120 from the second position B to a second transition B1 (as shown in FIG. 3D). Next, the roller 130 is released, such that the repulsive force between the first magnet 141 and the second magnet 142 pushes the connecting member 120 to the first direction F1 again, allowing the connecting member 120 to slide from the second transition B1 to the first position A. As a result, the connecting member 120 is positioned in the first position A (as shown in FIG. 3A), and a portion of the roller 130 is exposed from the housing 110.

Referring to FIG. 4 again, during sliding of the connecting member 120 from the second position B to the second transition B1, the connecting member 120 passes a second point P2. Because the center of the connecting member 120 is on a second axis X2, and the second axis X2 shifts from the second point P2, the second point P2 blocks the back path to the first transition A1, avoiding the connecting member 120 from sliding counter-clockwise. Thereby, allowing the connecting member 120 to slide clockwise to the second transition B1.

The electronic device 100 of the invention comprises a concealed roller 130, which is selectively exposed from the housing 110 or completely concealed in the housing 110, creating an aesthetic, ergonomic and smooth design.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a housing having a track and an aperture;
a connecting member moving along the track; and
a roller rotatably connected with an end of the connecting member, wherein the connecting member moves the roller to be exposed through the aperture or concealed in the housing.

2. The electronic device as claimed in claim 1, wherein the connecting member slides along the track between a first position and a second position.

3. The electronic device as claimed in claim 2, wherein when the connecting member is in the first position, a portion of the roller is exposed.

4. The electronic device as claimed in claim 2, wherein when the connecting member is in the second position, the roller is concealed in the housing.

5. The electronic device as claimed in claim 2, further comprising a first magnet and a second magnet, disposed on two ends of the connecting member.

6. The electronic device as claimed in claim 2, wherein the connecting member slides along the track between the first position and the second position, by passing through at least one transition.

7. The electronic device as claimed in claim 2, further comprising a magnetic set disposed at two ends of the connecting member, wherein the magnetic set provides a repulsive force to the roller to position the roller in a third position or a fourth position.

8. The electronic device as claimed in claim 7, wherein when the roller is under a force greater than the repulsive force, the roller departs from the third position or the fourth position.

9. The electronic device as claimed in claim 7, wherein the magnetic set comprises two magnets, facing each other with the same poles, disposed on the housing and the roller, respectively.

10. An electronic device, comprising:
a housing having a track;
a connecting member moving along the track between a first position and a second position; and
a roller rotatably connected with an end of the connecting member, wherein the connecting member moves from the first position to the second position, moving the roller from a third position to a fourth position.

11. The electronic device as claimed in claim 10, wherein when the roller is in the third position, a portion of the roller is exposed.

12. The electronic device as claimed in claim 10, wherein when the roller is in the fourth position, the roller is completely concealed in the housing.

13. The electronic device as claimed in claim 10, wherein the connecting member slides along the track between the first position and the second position, by passing through at least one transition.

14. The electronic device as claimed in claim 10, further comprising a magnetic set providing a repulsive force to the roller to position the roller in the third position or the fourth position.

15. The electronic device as claimed in claim 14, wherein the magnetic set comprises two magnets, facing each other with the same poles, disposed on the housing and the roller, respectively.

16. The electronic device as claimed in claim 10, further comprising a first magnet and a second magnet, disposed on two ends of the connecting member, facing each other with the same poles.
